(19) United States
(12) Patent Application Publication
(10) Pub. No.: US 2019/0177117 A1
(43) Pub. Date: Jun. 13, 2019

(54) ELEVATOR OPERATING PANEL

(71) Applicant: Kone Corporation, Helsinki (FI)

(72) Inventors: Niklas LOFBERG, Helsinki (FI); Christian WORTON, Helsinki (FI); Claudio STUPPl, Helsinki (FI)

(73) Assignee: Kone Corporation, Helsink (FI)

(21) Appl. No.: 16/276,967

(22) Filed: Feb. 15, 2019

Related U.S. Application Data
(63) Continuation of application No. PCT/EP2016/072199, filed on Sep. 19, 2016.

(51) Int. Cl. B66B 1/46; B66B 1/50; B66B 1/16; B66B 1/34

(52) U.S. Cl. CPC B66B 1/463; B66B 1/50; G09B 21/003; B66B 1/3461; B66B 1/16

(57) ABSTRACT

The invention relates to an elevator operating panel comprising at least one touchscreen panel with first touch screen areas being linked to first capacitive touch screen sensor, which touchscreen panel has a second touch screen area which is linked to the first touch screen sensor as well as to an additional second touch screen sensor, which second sensor is configured to be connected to a backup power supply.

This application is a continuation of PCT International Application No. PCT/EP2016/072199 which has an International filing date of Sep. 19, 2016, the entire contents of which are incorporated herein by reference.

The present invention relates to an elevator operating panel which is used for giving elevator calls, which kind of operating panel is usually located in elevator lobbies, at landing floors or within the elevator cars as car operating panel.

Particularly, in the case of car operating panels, the input device located in an elevator car has to have an alarm button which is intended for use by the passengers to indicate an abnormal situation. The pushing of the alarm button usually sets up a telecommunication connection to a remote service center. Alarm button in elevator cars should be acknowledgeable also by handicapped people and therefore has to have a tactile structure on its surface.

Nowadays, touch screen panels are increasingly used for elevator operating panels. As for the requirements for the alarm button which requires the tactile structure and a backup power supply in case of power failures, the elevator companies refrained from implementing the alarm button in the touch screen panel. Thus, the alarm button has been placed remote from the touch screen panel in current solutions.

It is object of the present invention to provide an elevator operating panel where the alarm button is integrated in the touch screen panel. This object is solved with an elevator operating panel according to claim 1. Advantageous embodiments of the invention are subject-matter of the dependent claims. Advantageous embodiments of the invention are also described in the specification and in the drawings.

According to the invention, the touch screen panel has first touch screen areas which are linked to first—preferably capacitive—touch screen sensor. These first touch screen areas refer to the usual areas in an operating panel intended for issuing elevator calls. The touch screen panel further has a second touch screen area, which is linked to said first capacitive touch screen sensor as well as to an additional second—preferably capacitive—touch screen sensor, which second touch screen sensor is connected to a backup power supply. Thus, according to the invention, a second sensor circuit with its own backup power supply is connected to the touch screen panel so that the alarm sensor is linked to two sensor circuits whereby one of these circuits is backed up via backup power supply. Accordingly, it is possible to provide an alarm button which meets safety requirements and which on the other hand can be integrated in a usual touch screen panel.

In a preferred embodiment of the invention, the second touch screen area has a tactile marking so that also handicapped people are able to immediately recognize the alarm button. In a simple embodiment of the invention, the second touch screen area is surrounded by a frame projecting from the surface of the touch screen panel. This frame forms the tactile marking and can be immediately recognized by handicapped, for example blind, people to belong to the area of the alarm button. Preferably the tactile marking is fixed on the touch screen panel, e.g. by screwing or gluing. By this means, the surface of the touch screen panel itself does not to require to be modified, as this would increase the manufacturing costs essentially. The tactile marking may preferably be a surrounding structure, e.g. a ring around the second touch screen area, projecting from the surface of the touch screen panel.

Preferably, an illumination- or animation device is located behind the second touch screen area, which illumination- or animation device is configured to be operated by activation of at least one of the touch screen sensors linked with the second touch screen area. By this means, the pressing of the alarm button can be immediately confirmed to the passenger by illuminating or animating the area of the second touch screen area.

Preferably the illumination- or animation device is connected to the backup-power supply of the second sensor. Via this measure no separate power supply has to be provided for the illumination or animation device. Another advantage is that the illumination device also works in case of a power-off.

Preferably the illumination device is located in connection with a back plate of the touch screen panel and has contacts with contact a power supply line for the second sensor. Via this measure no separate supply line has to be provided for the illumination device.

It is obvious for the skilled person that instead of a capacitive touchscreen also any other type of touchscreen may be used, as e.g. resistive systems, inductive systems SAW-Systems, optical Systems oder dispersive-signal-technology-systems. The second touch screen sensor then preferably uses the same system-touchscreen technology as the first touch screen sensor, although the applied systems may also be different.

In a preferred embodiment of the invention, a confirmation circuit is provided in the operating panel which is linked to the sensors linked with the second touch screen area. The confirmation circuit is connected to an output means of the operating panel, for example a loudspeaker, and which confirmation circuit is configured to be operated by the activation of at least one of the two touch screen sensors linked to the second touch screen area. Thus, a visual as well as an audio confirmation can be given to the passenger after he has pressed the alarm button. This provides safety and confirmation for handicapped passengers when getting in a trapped situation in an elevator car.

Preferably the first capacitive touch screen sensor and the second capacitive touch screen sensor are connected to separate interfaces. This facilitates the cabling of the operating panel, particularly in connection with the backup power supply. On the other hand for the first capacitive sensor current standard interfaces may still be used.

It is obvious that the invention allows the integration of the alarm button with separate backup power supply as well as with tactile markings within the confines of a common touch screen panel with slight modifications, i.e. provision of the separate second touch screen sensor.

The invention also relates to an elevator car having an operating panel according to the above description. The elevator car also has a loudspeaker and microphone which is activated in connection with the pressing of the alarm button in course of the set-up of a telecommunication connection.

The invention also relates to an elevator comprising at least one elevator car as described above. The elevator comprises a telecommunication connection connected to the operating panel of the elevator car which is configured to be set up in response to the operation of the second touch screen area.

It is clear for the skilled person that the above-mentioned embodiments may be combined with each other arbitrarily.

Following terms are used as synonym: first/second touch screen area—first/second touch area; first/second capacitive touch screen sensor—first/second sensor—first/second touch screen sensor; tactile marking—projecting frame—second area—second touch screen area—alarm button;

The invention is hereinafter described by the aid of an embodiment in connection with the appended drawings. In the drawings:

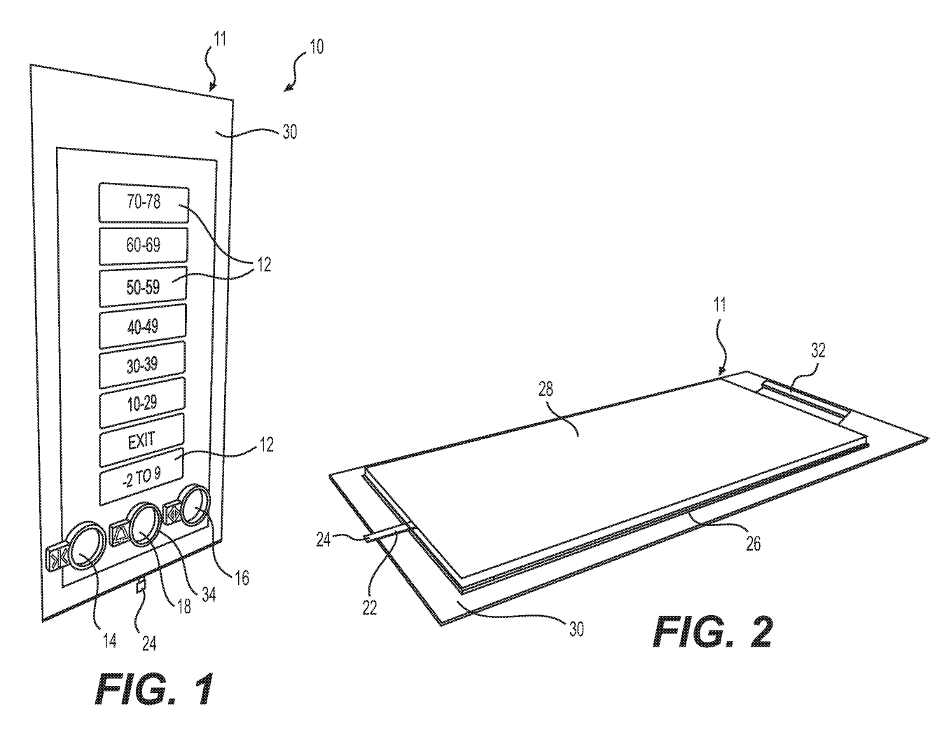

FIG. 1 shows the front side of an inventive car operating panel,

FIG. 2 shows a perspective view of the back side of the car operating panel of FIG. 1,

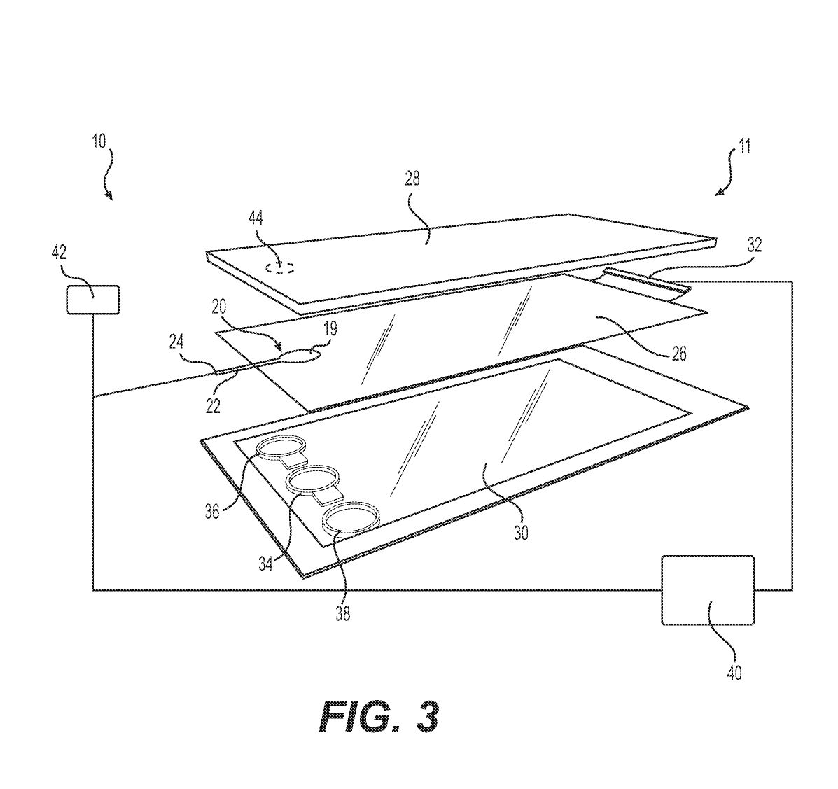

FIG. 3 shows an explosive drawing of the car operating panel of FIGS. 1 and 2,

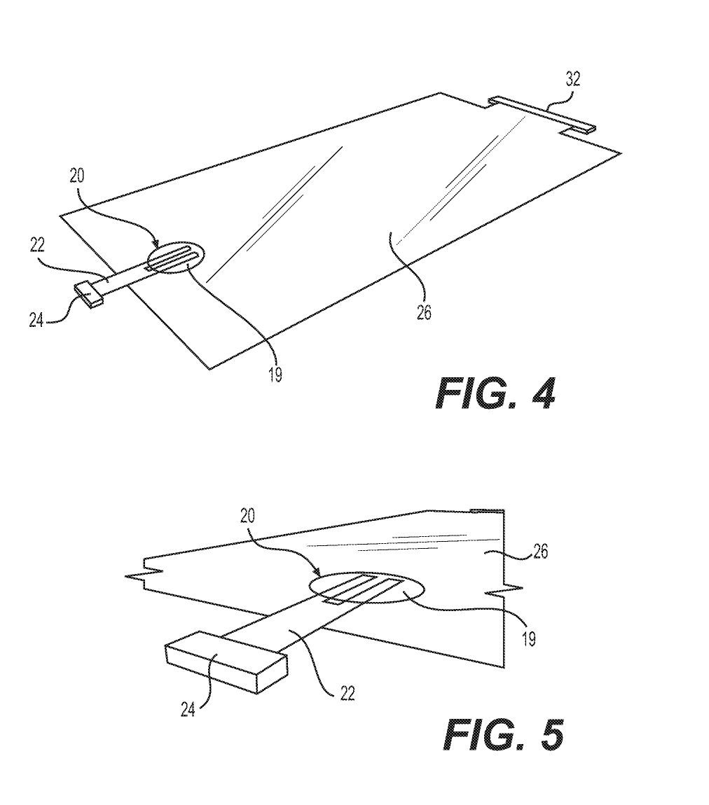

FIG. 4 shows a perspective drawing showing the addition of a second touch screen sensor in connection with the touch screen panel, and

FIG. 5 shows s a perspective view of a detail of FIG. 4 in the area of the second touch screen sensor.

FIG. 1 shows a car operating panel 10 with a touchscreen panel 11 comprising several first touch screen areas 12 for giving a car call to different floors of a building, two exceptional touch screen areas 14, 16 for the opening and closing of the car door as well as a second touch screen area 18 for an alarm button. Each of the buttons 12, 14, 16, 18 of the car operating panel is linked with a foil-like first touch screen sensor 26 for the respective function. The first touch screen sensor thus has several touch screen areas for different functions. The first touch screen sensor 26 is connected via a first interface 32 to a control 40 of the operating panel 10.

Additionally, the second touch screen area 18 for the alarm button is linked to a second capacitive touch screen sensor 20 which is shown in FIGS. 4 and 5. The second capacitive touch screen sensor 20 has its own supply cable 22 which is connected via a second interface 24 to a backup power supply 42 as well as to the control 40 of the operating panel 10, e.g. a microprocessor. This second touch screen sensor 20 is arranged additionally to the first capacitive touch screen sensor (foil) 26 located between the back plate 28 and the front plate 30 of the touch screen panel 11. Each sensor area 12-18 of the first capacitive touch screen sensor 26 is connected to a separate connector of the first interface 32.

The second interface 24 of the second sensor 20 is not only connected to the operating panel 40 but also to a backup power supply 42 to remain active even in case of a power failure. This is essential to be able to detect trapped passengers also in case of a power-off. The alarm button 18 has on the front plate 30 of the touch screen panel 11 a ring frame 34 which can easily be acknowledged by handicapped people, for example by blind people, to belong to the alarm button. Also the door open and door closed buttons may be marked with a respective ring 36, 38 protruding from the surface of the front plate 30 and surrounding the respective touch sensitive area of the buttons 14, 16.

Additionally, behind the second touch screen area 18, an illumination device 44 is located in connection, e.g. embedded in the back plate 28 of the touch screen panel 11 which is arranged to be illuminated after the second touch screen area 18 has been pushed by a passenger. The illumination device 44 preferably connects with the supply line 22 for the second sensor when the components 26, 28, 30, 20 of the touchscreen panel are mounted together. Via this means no separate power line is necessary for the illumination device. Additionally, an audio confirmation can be given by a loudspeaker (not shown) located in connection with the operating panel.

The invention is not limited to the described embodiments but can be varied within the scope of appended patent claims.

### LIST OF REFERENCE NUMBERS

10 car operating panel
11 touch screen panel
12 first touch screen area
14 first exceptional touch screen area
16 second exceptional touch screen area
18 second touch screen area
20 second capacitive touch screen sensor
22 supply line
24 second interface
26 first touch screen sensor—sensor foil
28 back plate
30 front plate
32 first interface
34 alarm button ring frame—tactile marking of alarm button
36 door open button ring frame
38 door close button ring frame
40 operating panel control
42 backup power supply
44 illumination device

1. Elevator operating panel comprising at least one touchscreen panel with first touch screen areas being linked to first touch screen sensor,
which touchscreen panel has a second touch screen area which is linked to the first touch screen sensor as well as to an additional second touch screen sensor, which second sensor is configured to be connected to a backup power supply.

2. Elevator operating panel according to claim 1, wherein the second touch screen area has a tactile marking.

3. Elevator operating panel according to claim 2, wherein that the tactile marking is formed by a frame projecting from the surface of the touchscreen panel surrounding the second touch screen area.

4. Elevator operating panel according to claim 1, wherein the second sensor is connected in parallel to the first sensor.

5. Elevator operating panel according to claim 1, wherein an illumination- or animation device is located behind the second touch screen area, which illumination- or animation device is configured to be operated by activation of at least one of the touch screen sensors linked with the second touch screen area.

6. Elevator operating panel according to claim 5, wherein an illumination- or animation device is connected to the backup-power supply.

7. Elevator operating panel according to claim 1, wherein a confirmation circuit is linked with the sensors linked to the second touch screen area, which confirmation circuit is connected to an output means of the operating panel, and which confirmation circuit is configured to be operated by activation of at least one of the two touch screen sensors linked to the second touch screen area.

8. Elevator operating panel according to claim 1, wherein the first sensor has a first interface and the second sensor has a separate second interface for connection with a control of the operating panel, and that the second interface is also connected with a backup power supply.

9. Elevator operating panel according to claim 1, wherein the backup power supply is a capacitor or battery.

10. Elevator operating panel according to claim 1, wherein the first and second sensors are capacitive sensors.

11. Elevator operating panel according to claim 1, wherein the second touch screen area is integrated in the touch screen panel.

12. Elevator car having an operating panel according to claim 1, which elevator car also has a loudspeaker and microphone which is activated in connection with the pressing of the alarm button.

13. Elevator comprising at least one elevator car according to claim 12, comprising a telecommunication connection connected to the operating panel which is configured to be set up in response to the operation of the second touch screen area.
